(19) United States
(12) Patent Application Publication
(10) Pub. No.: US 2003/0233419 A1
(43) Pub. Date: Dec. 18, 2003

(54) Enhanced email management system

(76) Inventor: Joerg Beringer, Frankfurt (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/339,779

(22) Filed: Jan. 8, 2003

Related U.S. Application Data
(60) Provisional application No. 60/347,044, filed on Jan. 8, 2002.
(60) Provisional application No. 60/420,539, filed on Oct. 22, 2002.

(51) Int. Cl. G06F 15/16

(52) U.S. Cl. 709/206; 709/207

(57) ABSTRACT

Systems and techniques to manage email documents using context information. In general, the technique includes displaying context information related to an email document. This context information might include a recent received email list, a recent sent email list, a project task description, or a suggested operation to perform on the email document. Furthermore, profile information related to a user associated with the email document may be displayed.

### CROSS-REFERENCE TO RELATED APPLICATIONS

This application claims the benefit of the priority of U.S. Provisional Application Serial No. 60/347,044, filed Jan. 8, 2002, and entitled “COLLABORATIVE SALES APPLICATION” and No. 60/420,539, filed Oct. 22, 2002, and entitled “COLLABORATIVE SALES APPLICATION,” the disclosures of which are incorporated by reference

### BACKGROUND

The present application describes systems and techniques relating to electronic mail (“email) document management systems, for example, context-dependent email management.

“Email document management systems” comprise both personal computer (PC) application-based as well as World Wide Web-based (WWW or Web) email document management. Popular PC email applications include Microsoft Outlook, Microsoft Exchange, Eudora, and Lotus Notes. Popular Web-based email systems include Hotmail and Yahoo! Mail. In addition, online services such as America Online have developed their own email document management systems. Typically, these email document management systems support multiple folders in which to store email, show email header and subject line information, and provide a contact list or address book feature. Some of these systems offer a calendar management system. In addition, some allow the user to sort email documents by different fields, such as by sender, recipient, subject, and received date/time.

### SUMMARY

The present application discloses an email document management system capable of displaying profile information or context information related to a selected email document, its senders, recipients, subject matter, etc.

The present inventor recognized that conventional email management applications do not adequately support differentiating email documents according to their relevance to a particular subject matter of interest. Furthermore, conventional email management applications do not provide adequate information relating to the context of the email or its subject matter. Accordingly, the present inventor recognized the potential advantages of providing context information for email documents.

In one aspect, profile information associated with the sender of the document is displayed, for example, information that may include a photograph of the sender. In another aspect, context information related to the document is displayed, for example, a recent received email list, a recent sent email list, a project task description, or a suggested operation to be performed on the received email. In another configuration, a recent mailto list, a frequent mailto list, or a list of suggested recipients to an email may be displayed. In another implementation, an email monitor window or an expected replies window may be displayed.

These and other aspects of the present invention may allow an end user to more intuitively and efficiently manage his email messages. In addition, the end user is presented with information related to a received email that may allow him to gain a greater understanding of the context in which the email was sent or of the background of the sender of the email.

Details of one or more implementations are set forth in the accompanying drawings and the description below. Other features and advantages may be apparent from the description and drawings, and from the claims.

### DRAWING DESCRIPTIONS

These and other aspects will now be described in detail with reference to the following drawings.

FIG. 1 shows a screenshot illustrating examples of context information.

FIG. 2 shows a block diagram of a system including an enhanced email client.

FIG. 3 shows a screenshot illustrating examples of context information.

FIG. 4 shows an example of an Email Monitor window.

FIG. 5 shows an example of an Expected Replies window.

FIG. 6 shows an example format for an email document.

FIG. 7 shows a screenshot illustrating examples of context information.

Like reference symbols in the various drawings indicate like elements.

### DETAILED DESCRIPTION

The systems and techniques described here relate to email document management systems.

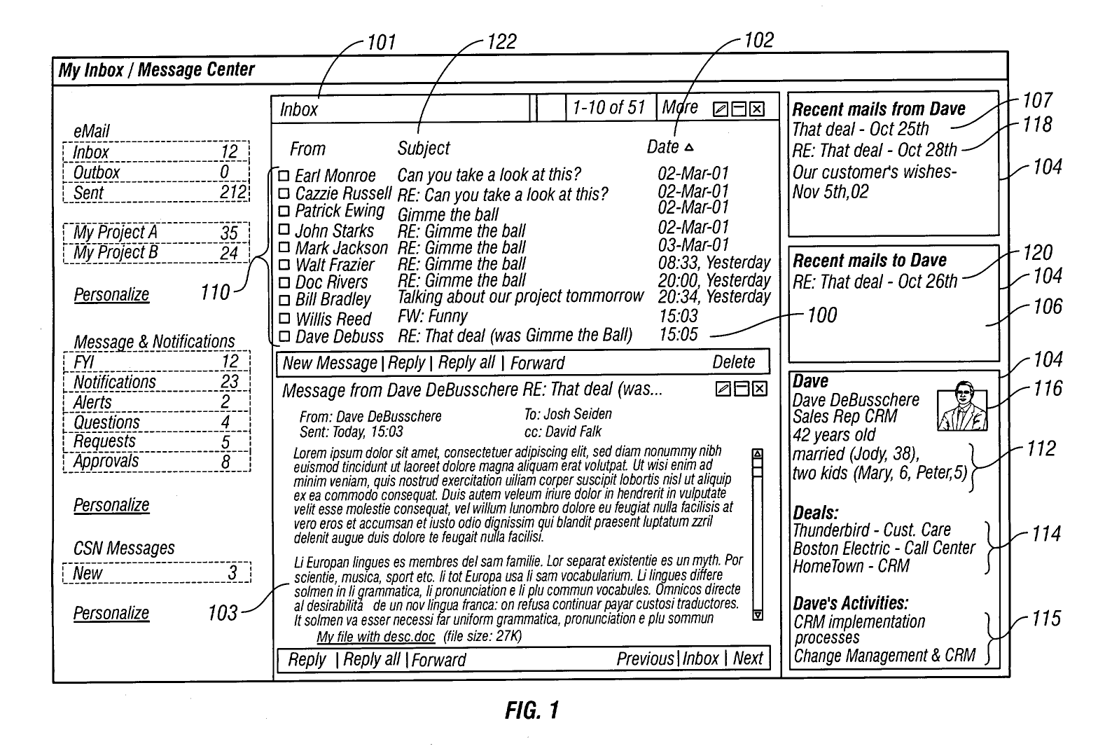

FIG. 1 illustrates a screenshot of a sample display of email documents 110 in a folder 101, in which a current email document 100 has been selected. In the figure, the illustrated folder 101 represents the Inbox, but the display could be similar for other folders. As shown, the email documents 110 are sorted by a Date field 102. However, they could also be sorted by additional or different fields. A preview pane 103 may display a preview of an email document 100, e.g. as a floating window.

In this discussion, an “associated user” of an email document 100 refers to a sender of the email document 100, a recipient of the email document 100, or a group to which a sender or a recipient belong. In contrast, an “end user” refers to the person utilizing the email document management system of this application. An end user may also be an associated user. A “recipient” may include not only a recipient in the “To” field, but also a recipient in the “cc” or “Bcc” fields. A “group” may include, among others, an email distribution group or a project workgroup.

Context information 104 relating to an email document 100 or to an associated user of an email document 100 may be displayed. In general, context information 104 includes more or different information than simply the commonly-used fields of “Subject” 122, “To”, “From”, “cc”, “Bcc”, “Date”, etc.

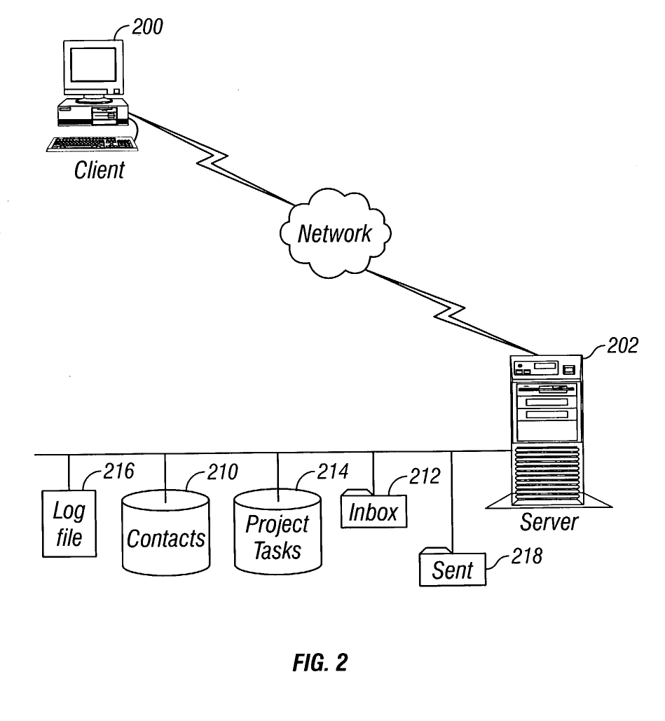

The context information 104 may include profile information 105 of an associated user of an email document 100. The profile information 105 may include the user's contact information, personal information 112, recent projects 114 and activities 115, and photograph or icon 116. The profile information 105 may be obtained by searching a contacts database 210. Profile information for a particular sender may be manually entered into the contacts database by the end user. As shown in FIG. 2, the profile database 210 may be located either on a client 200 or a server 202. Profile information 105 may also be obtained from metadata associated with the email document 100, for example, information transmitted along with the email document 100.

FIG. 6 shows an example format for an email document 650. The email document includes a header 651, which includes an identifier 652 and metadata 654, and a payload 655, which includes a body 656 and may include one or more attachments 658. The identifier 652 may include information for the “From”, “To”, “Sent”, and “cc” fields shown in FIG. 1. The body 656 may include text, which forms the main body of the email, shown in the preview field in FIG. 1. The metadata 654 may include context information associated with the email, such as the profile information and recent mail lists in the context portion 104 of the display.

As shown in FIG. 1, context information 104 may also include a recent received email list 107 from the sender of an email document 100 or from any other associated user of the email document 100. The recent received email list 107 may also include email documents previously received from a group of which the sender is a member. Thus, previous email discussions relating to the subject matter of the current email document 100 are readily accessible to the end user. Selecting an email document 118 from the recent received email list 107 may open the email document 118. Alternatively, selecting an email document 118 from the recent received email list 107 may invoke another operation, including initiating a reply email. The choice of which operation is invoked may be individually configurable. The amount of time for an email document 118 to be considered “recent” may also be individually configurable. In addition, the end user may generate a recent received email list 107 for any contact in a contacts database 210. This may be implemented by, for example, offering the appropriate option when browsing in a contact list, or by offering the appropriate option when selecting a context-specific menu for a contact, e.g., by “right-clicking” on the contact in a Microsoft ® Windows ® environment.

The recent received email list 107 may be implemented by searching the end user's inbox 212 and/or other email folders using appropriate search criteria. This search may be initiated by the end user. Alternatively, the search may be conducted automatically, for example, upon receipt of the email document 100 or upon startup of the email document management system, so that when the end user selects the current email document 100, the recent received email list 107 is quickly available.

Context information 104 may also include a recent sent email list 106 to an associated user of an email document 100. Selecting an email document 120 from the recent sent email list 106 may open the email document 120. Alternatively, selecting an email document 120 from recent sent email list 106 may invoke another operation, including initiating a reply email. The choice of which operation is invoked may be individually configurable. The recent sent email list 106 may include an email document 120 previously sent to the sender of a current email document 100 or sent to a group of which the sender is a member. Additionally, the recent sent email list 106 may include an email document sent to any other recipient of the current email document 100. The amount of time for an email document to be considered “recent” may be individually configurable.

If the end user was not originally included in a conversation thread, but is brought into the thread later on, it may be useful to enable him to have access to previous email documents in that conversation thread. Thus, the recent sent email list 106 may also include one or more email documents 120 that were sent by a member of a group to which an associated user of the current email document 100 belongs. In another implementation, the recent sent email list 106 may include an email document 120 having the same subject field 122 as the current email document 100.

The recent sent email list 106 may include an email document 120 that discusses similar subject matter as the current email document 100. Identification of the similar email document 120 may be made by searching the contents of email documents on a server 202. In one configuration, this search may not include email documents that have been designated ‘private.’

Context information 104 may be collected by searching the contents of the email document 100. Context information 104 may also be collected from metadata associated with the email document 100. Context information, such as lists of previous sent 106 and received 107 email documents, may be collected by searching one or more email folders belonging to the recipient, or by searching email documents stored on a mail server 202.

It may be useful to quickly identify and sort email documents by the projects with which they are associated. Thus, the context information 104 may include a project task description 301 relating to the subject matter of the email document 100. This project task description 301 may be obtained by searching the email document 100 and comparing it to existing project task descriptions (for example, in a task database 214) to identify with which task the email document 100 is associated. Alternatively, the project task description 301 may be obtained by using metadata associated with the email document 100 to retrieve the project task description 301 from a project task list. Additionally, the metadata may contain all the information required to display the project task description 301. The email document list 110 may be sorted by a project task field 303, in a similar manner as by subject field 122, sender, date, etc. Although displaying a project task description 301 is specifically mentioned above, other types of business information may be displayed, for example, key performance indicators (e.g. order volume.).

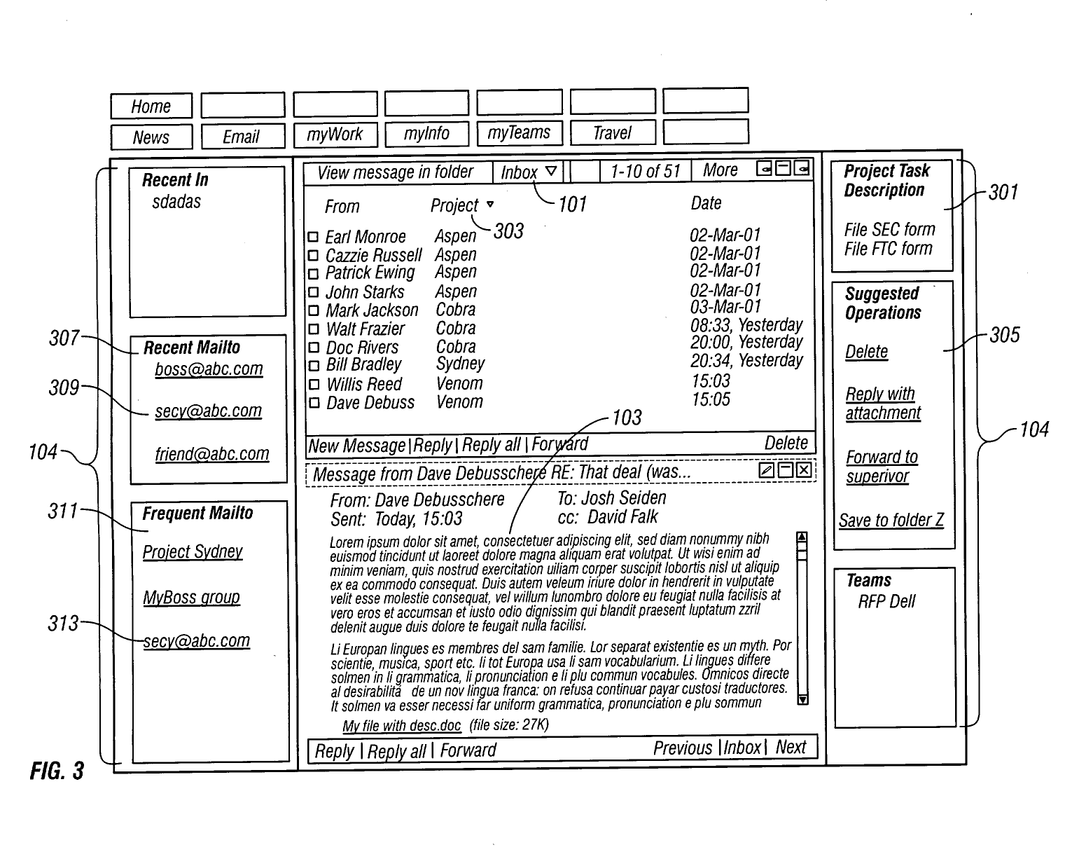

The context information 104 may include one or more suggested operations 305 to perform on the current email document 100, as illustrated in FIG. 3. These suggestions 305 may be determined based on the subject field 122 of the email document 100, the contents of the email document 100, other portions of the context information 104, or past operations performed on similar email documents. For example, the current email document 100 may be compared to a log file 216 that contains information regarding past operations performed on other email documents. If the log file 216 indicates that a particular operation (e.g. delete, move to a particular folder, forward, etc.) has been performed on a certain number of email documents containing the same or similar subject field 122 as the current email document 100, then the end user may be offered the same operation as a suggested operation. The suggested operations 305 may be based on a software engine that analyzes the contents of the current email document 100 and suggests an appropriate action 305. For example, possibilities include a suggestion that the document be deleted, forwarded to a particular recipient, or moved to a particular folder.

When the software user clicks on or otherwise selects an email document 100 in the folder's 101 list of email documents 110, the preview pane 103 changes to display at least partial contents of the email document 100. In addition, all the context information 104 may be updated to correspond with the chosen email document 100. Clicking on or otherwise selecting an email document from the recent received email list 107 or from the recent sent email list 106 may open a new window showing the contents of that email document. Alternatively, clicking on or otherwise selecting that email document may allow the software user to perform other functions, such as composing a follow-up email. In another embodiment, clicking on or otherwise selecting an email document listed in the context information 104 will make that email document become the current email document 100. In that case, the context information 104 would update accordingly.

Email communication has relatively stable communication patterns; the mining of “sent mail” folders 218, whether on clients 200 or servers 202, may thus provide useful information. For example, an end user's sent mail folder 218 may be searched to offer a “Recent Mailto” list 307, i.e. a list of people, groups, or email addresses 309 to whom the end user has recently sent an email document. The amount of time for an email document to be considered “recent” may be individually configurable. Selecting one or more of these addresses 309 may initiate the creation of a new email document. Alternatively, selecting one of these addresses 309 may retrieve associated contact and profile information from the contacts database 210.

An end user's sent mail folder 218 may be parsed to recognize and propose clusters of one or more recipients with whom the end user is frequently communicating. The level of communication to be considered “frequent” may be individually configurable. This information may be used to generate and offer a “Frequent Mailto” list 311. The parsing process may be triggered by the end user. Selecting one or more of these addresses 313 may initiate the creation of a new email document. Alternatively, selecting one of these addresses 309 may retrieve associated contact and profile information from a contacts database 210. Additionally, if the parsing process determines that the end user frequently sends email documents to a cluster of recipients, the end user may be offered an option to create or modify an email group to include the cluster of recipients.

The parsing process may further monitor outgoing email documents to determine whether a certain email group should be included. For example, if an email document is addressed to recipients who comprise a certain configurable percentage of an email group, the end user may be prompted to include the entire email group. This might be implemented with a prompt such as: “Do you intend to write to group ABC? If yes, persons X and Y belong to that group as well. Do you wish to include persons X and Y?”

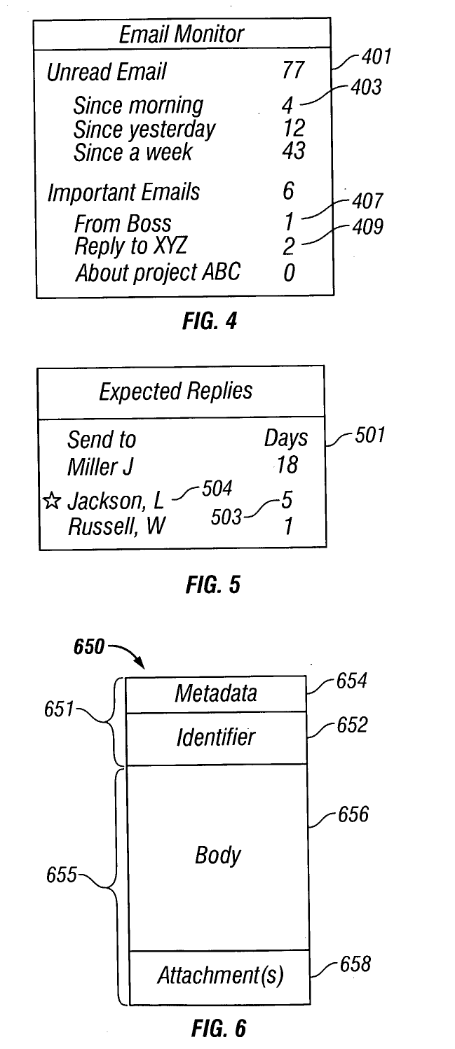

Certain individuals use email in an intensive manner. For such “power users,” it may be useful to provide a means to monitor email without having to read or manually scan the list of email documents 110. Such users may need notifications, statistics, or other metrics that enable them to recognize urgent or important email. Thus, as shown in FIG. 4, an email monitor window 401 may display the number of new email documents received since the beginning of the day 403. This time period may be individually configurable. The email monitor window 401 may also indicate when a new email document is received from an sender that the end user has designated ‘important’ (for example, from his supervisor 407), or when an email document with metadata marking it ‘important’ has been received. Additionally, the end user may be waiting for a reply to a certain email. The email monitor window 401 may notify the end user when the waited-for reply 409 has been received. This feature may be implemented by, for example, the end user selecting a reply notification option when sending an email, which would then cause certain notification metadata to become associated with the waited-for reply. There may, of course, be other ways to implement an option where the end user may declare that replies to a particular outgoing email document should be added to the email monitor window 401. Alternatively, as shown in FIG. 5, a separate Expected Replies window 501 may be implemented that, for example, monitors the amount of time 503 that the end user has been waiting for a reply email from a certain recipient 504.

An auto-classification engine may parse the subject or text of a current email document 100 and search for additional related context information. The auto-classification engine may be a search engine that collects and indexes documents based on information in a query string. The auto-classification engine may use terms in the email metadata or body to generate the query string.

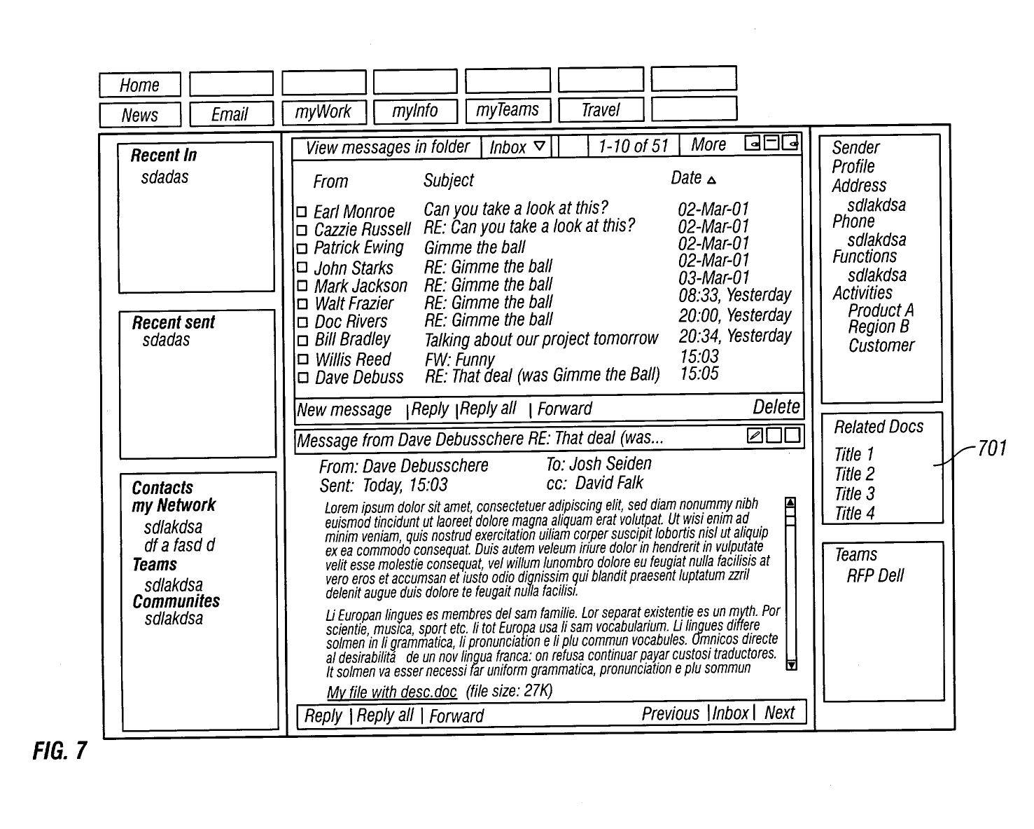

The additional context information may include a list of email documents that are related to the content of the current email document 100. As illustrated in FIG. 7, this additional information may also include non-email documents 701 related to the content of the current email document 100 by searching the end user's folders on the client or particular folders on a server. Additionally, news items or links to news items related to the current email document 100 may be displayed. Such news items may be identified by determining the contents of the current email document 100 and comparing them with news items on the Internet or an intranet. Further, a list of persons engaged in work related to the content of the current email document 100 may be displayed. This list may be determined by comparing the contents of the current email document 100 to a database that keeps track of the current project tasks assigned to various individuals.

In all of the various configurations and implementations described above, the choice of which context information 104 to display may be individually configurable. Furthermore, the various databases that may be used may be located either on the client 200 or the server 202. Similarly, the log file 216 may reside either on the client 200 or the server 202.

As used herein, the terms “electronic document” and “document” mean a set of electronic data, including both electronic data stored in a file and electronic data received over a network. An electronic document does not necessarily correspond to a file. A document may be stored in a portion of a file that holds other documents, in a single file dedicated to the document in question, or in a set of coordinated files.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Although only a few embodiments have been described in detail above, other modifications are possible. Other embodiments may be within the scope of the following claims.

What is claimed is:

1. A method for managing electronic messages, the method comprising:
identifying a user associated with a received message;
retrieving profile information corresponding to the identified user; and
presenting the received message and the retrieved profile information to an end user.

2. The method of claim 1, wherein the received message comprises an identifier and a body, and
wherein said presenting comprises
displaying the identifier in a first portion of a display,
displaying the body in a second portion of the display, and
displaying the profile information in a third portion of the display.

3. The method of claim 1, wherein the identified user is an associated user.

4. The method of claim 1, wherein the identified user is the sender of the received message.

5. The method of claim 1, wherein said retrieving comprises retrieving profile information from a profile database including a plurality of entries, each entry including an associated user and corresponding profile information.

6. The method of claim 1, wherein said retrieving comprises retrieving profile information from metadata transmitted in connection with the received message.

7. The method of claim 1, wherein said retrieving comprises retrieving profile information from a database.

8. The method of claim 1, wherein the profile information is mined from at least one of an email message store and a non-email message store.

9. The method of claim 1, wherein the profile information comprises at least one of contact information, personal information, recent projects, activities, a photograph, and an icon.

10. A method for managing electronic messages, the method comprising:
receiving an email from a sender, the email including an identifier and a body;
retrieving context information associated with the email;
displaying the identifier in a first portion of a display;
displaying the body in a second portion of the display; and
displaying the context information in a third portion of the display.

11. The method of claim 10, wherein said retrieving comprises retrieving context information from metadata transmitted in connection with the email.

12. The method of claim 10, wherein said retrieving comprises retrieving context information from a database.

13. The method of claim 10, wherein the context information comprises a recent received email list from an associated user.

14. The method of claim 13, wherein the associated user is the sender of the email.

15. The method of claim 13, wherein said retrieving comprises searching an email folder.

16. The method of claim 10, wherein the context information comprises a recent sent email list to an associated user.

17. The method of claim 16, wherein the associated user is the sender of the email.

18. The method of claim 16, further comprising:
determining one or more emails containing subject matter similar to subject matter of the received email.

19. The method of claim 18, wherein the recent sent email list comprises said emails containing subject matter similar to subject matter of the received email.

20. The method of claim 10, wherein the context information comprises a project description related to subject matter of the email.

21. The method of claim 20, wherein said retrieving comprises retrieving the project description from metadata transmitted in connection with the email.

22. The method of claim 20, wherein the project description comprises a list of people involved in the same project.

23. The method of claim 20, wherein the project description comprises a project task description related to subject matter of the email.

24. The method of claim 20, said retrieving comprising:
analyzing subject matter of the email; and
retrieving the project description from a database in accordance with said analyzing.

25. The method of claim 10, wherein said retrieving comprises searching at least one log file of past operations.

26. The method of claim 25, further comprising displaying at least one suggested operation in accordance with said searching.

27. The method of claim 10, wherein the context information comprises a recent mailto list.

28. The method of claim 27, wherein said retrieving comprises parsing a sent mail folder.

29. The method of claim 10, wherein the context information comprises a frequent mailto list.

30. The method of claim 29, wherein said retrieving comprises parsing a sent mail folder.

31. The method of claim 10, wherein the context information comprises an email monitor window.

32. The method of claim 31, wherein the email monitor window comprises metrics to enable an end user to prioritize or identify important or urgent messages.

33. The method of claim 10, wherein the context information comprises an expected replies window.

34. The method of claim 10, wherein the context information comprises news relevant to subject matter of the received email.

35. The method of claim 34, wherein the news comprises a hyperlink.

36. The method of claim 10, further comprising:
analyzing subject matter of the received email; and
suggesting at least one operation in accordance with said analyzing.

37. The method of claim 10, further comprising identifying and making accessible at least one related email similar to subject matter of the received email.

38. The method of claim 10, further comprising suggesting at least one additional recipient to be added to an outgoing email.

39. The method of claim 10, further comprising suggesting at least one recipient to be removed from an outgoing email.

40. An article comprising a machine-readable medium storing instructions operable to cause one or more machines to perform operations comprising:
identifying a user associated with a received electronic message;
retrieving profile information corresponding to the identified user; and
presenting the received electronic message and the retrieved profile information to an end user.

41. The article of claim 40, wherein the received electronic message comprising an identifier and a body, and
wherein said presenting comprises
displaying the identifier in a first portion of a display comprises
displaying the body in a second portion of the display; and
displaying the profile information in a third portion of the display.

42. An article comprising a machine-readable medium storing instructions operable to cause one or more machines to perform operations comprising:
receiving an email from a sender, the email including an identifier and a body;
retrieving context information associated with the email;
displaying the identifier in a first portion of a display;
displaying the body in a second portion of the display; and
displaying the context information in a third portion of the display.

43. The article of claim 42, wherein said retrieving comprises retrieving context information from metadata transmitted in connection with the email.
